(19) United States
(12) Patent Application Publication
(10) Pub. No.: US 2006/0095171 A1
(43) Pub. Date: May 4, 2006

(54) Methods, devices and systems for high-speed autonomous vehicle and high-speed autonomous vehicle

(76) Inventors: William L. Whittaker, Pittsburgh, PA (US); Chris Urmson, Pittsburgh, PA (US); Byron Keith Smith, Georgetown, PA (US); Hiroki Kato, Pittsburgh, PA (US); Nicholas Michael Miller, Hermosa Beach, CA (US); Kevin Michael Peterson, Pittsburgh, PA (US); Matthew Kai Johnson-Roberson, Buffalo, NY (US); Vanessa Hodge, Pittsburgh, PA (US); Michael Neil Clark, Melbourne, FL (US); Joshua Anhalt, Pittsburgh, PA (US)

Correspondence Address: REED SMITH LLP, P.O. BOX 488, PITTSBURGH, PA, 15230-0488, US

(21) Appl. No.: 10/980,389

(22) Filed: Nov. 3, 2004

Related U.S. Application Data
(60) Provisional application No. 60/624,201, filed on Nov. 2, 2004.

(51) Int. Cl. G01C 22/00

(52) U.S. Cl. 701/25; 701/23

(57) ABSTRACT

The invention comprises an autonomous off-road vehicle capable of traveling at high speeds. Preferred embodiments of the invention comprise a system for sensory instrument stabilization comprises three axis assemblies movable about three orthogonal axes. The invention also comprises novel methods for generating a high accuracy route for a robotically controlled vehicle. Other aspects of the invention include drive time, perception-based path adjustments to steer a robotic vehicle within an intended corridor. Another embodiment of the invention comprises the consideration of vehicular dynamics in generating a high accuracy route and in steering a robotic vehicle within an intended corridor.

### CLAIM OF PRIORITY

This invention claims priority to a United States provisional application having Ser. No. ______ filed Nov. 2, 2004.

### FIELD OF THE INVENTION

The invention relates generally to methods, devices, and systems for the navigation of robotic non-supervised autonomous vehicles. Specifically, the invention relates to a vehicle equipped with methods, devices, and systems that render the vehicle capable of high-speed autonomous traversal over unrehearsed terrain. Aspects of the invention can, however, apply to non autonomous robotic vehicles and would therefore apply to the fields of driver assistance and telematics.

### BACKGROUND OF THE INVENTION

Robots capable of traversing through rough terrain are known. However, such robots are restricted in that most are capable of traveling only at low speeds. Robots capable of traversing off-road terrain at higher speeds have been restricted in that the technology has only allowed such robots to travel through simple off-road scenarios. Further, previous autonomous off-road travel (“AOT”) also depended heavily on a previewed route. The benefits of a previewed route remain, however, the ability for high-fidelity local sensing of the off-road environment would greatly enhance the high-speed AOT.

As robots are developed for higher speeds, the electromechanical capabilities are evolving. However, the technology has not kept pace with the demands presented by high-speed off-road travel. Until now, autonomous off-road vehicles have fallen short of performance ambitions.

Stabilization of sensing instrumentation is an important aspect of high-speed AOT. Instrumentation such as light detection and ranging (“LIDAR”) technology and stereovision systems are considered essential to off-road mobile robot capability. Diverse and changing topology coupled with terrain induced excitations can affect the level of accuracy of data collected by such instrumentation, and high-speed AOT has been limited until now because of the inadequate methods and mechanics employed to stabilize such instrumentation. Further, it is essential that the instrumentation be directed at the desired target, and if needed, to remain fixed on said target for a desired amount of time. Until now, the ability to remain actively fixed on a target under high-speed off-road conditions has been severely limited. Thus, there exists a need for a device and method to stabilize the sensory instrumentation under high-speed off-road conditions to enable more accurate sensory perception, and a need to enable the sensory instrumentation to remain fixed on target under high-speed off-road conditions.

With respect to route planning for high-speed AOT, it is known to predrive a route, memorize that route, and to drive along the memorized route. It is also known to drive a prescribed path from GPS waypoints only. Such prior methods have drawbacks, however, including reliance on low-resolution data and the inability to account for changes to the rehearsed path or for “new” or previously unseen obstacles in the rehearsed path. It would therefore be desirable to provide systems and methods to enable the generation of a route with extremely high resolution without undue strain on resources such as processing, system memory, and human editing time. It would further be desirable to provide a system and method that would consider the capabilities of the vehicle upon creating the route. Still further, it would be desirable to provide a route for high-speed AOT that accounts for terrain characteristics and conditions to establish vehicle speeds along the intended route, for example, speeds through straight-aways, speeds through sharp turns, and speeds for traveling on inclines.

Another necessary element for high-speed AOT is the ability to drive both robustly and quickly. Extensive preknowledge of the terrain coupled with the ability to sense the local surroundings in a high-fidelity way will increase performance of high-speed AOT. Further, at present, there is no system or method that significantly accounts for the dynamic vehicle modeling to provide a pre-planned route and to command a vehicle within the intended route. Accounting for vehicular dynamics would greatly enhance performance of all robotically controlled vehicles, and in particular, robotic vehicles for high-speed autonomous off-road travel.

### SUMMARY AND OBJECTS OF THE INVENTION

A presently preferred embodiment of the present invention comprises an autonomous off-road vehicle that is able to travel at high-speeds. The methods, systems, and hardware which make up the present invention can be not only utilized on the high-speed off-road autonomous vehicle but have application in numerous other fields of mobility including vehicles having human controllers.

One embodiment of the invention comprises a system for sensory instrument stabilization comprising a first axis assembly operable to be rotated about a first axis, a second axis assembly coupled with the first axis assembly, the combination of said first and second axis assemblies providing the sensory instrumentation with ability to move about said first and second axes, and a third axis assembly coupled with the first axis assembly and the second axis assembly so that axes are orthogonal to each other. This orthogonal coupling of the first, second and third axis assemblies provide a sensory stabilization means movable about these orthogonal axes. The sensory stabilization system also includes a processing means in communication with means to detect angular velocity and acceleration on each of the axis assemblies. The processing means also actuates actuators to rotate at least one of the assemblies in response to a detected angular acceleration or velocity. The first axis assembly has a moment of inertia higher than the second and third axis assemblies and the second axis assemble has a moment of inertia higher than that of the third axis assembly. The processing means is further operable to instruct at least one of the actuators to rotate at least one of the assemblies an angular distance proportional to the detected angular acceleration or velocity necessary to direct the assembly along a preselected vector, or to instruct the actuators to provide an opposite angular acceleration force proportional to the force detected by the system.

The invention also comprises novel methods for generating a high accuracy route for a robotically controlled vehicle. The steps to the claimed methods comprise gathering mapping data related to a region of intended travel and fusing said mapping data into a model. According to a preferred embodiment of the present invention, the region and model corresponds to an actual location. The method also provides a travel corridor within the model, and the travel corridor corresponds to an actual corridor through the actual location. The invention now provides for the running of a sensory means over the actual corridor to collect high-resolution data related to the conditions of said actual corridor. Additionally, the invention assigns a plurality of travel costs associated with said actual corridor based on the collected data related to conditions of said actual corridor and mapping data. A route is generated through said corridor based on a determination of the costs. In alternate embodiments, the route is parsed into segments that are assigned to human editors, and a second route comprising said human edited route segments is generated. The invention also assigns speed values to the route and requires the vehicle to travel a selected speed based on said speed values.

The invention further comprises a dynamic vehicle model, which is used to prepare a route or real-time intended driving path. With respect to a driving path, the invention provides for perception based path adjustments to steer a vehicle to which a route may have been provided.

Is an object of the invention to provide a device, system, and method to stabilize the sensory instrumentation under high-speed off-road conditions.

It is another object of the invention to enable the sensory instrumentation to remain fixed on a target under high-speed off-road conditions.

It is still another object of the invention to provide systems, devices, and methods to enable the generation of a route with extremely high resolution without undue strain on resources such as processing, system memory, and human editing time.

It is still a further object of the invention to provide systems, devices, and methods that would consider the capabilities of the vehicle upon creating a route and upon selecting an intended drive path.

It is still yet another object of the invention to provide a route for high-speed AOT that accounts for terrain characteristics and conditions to establish vehicle speeds along the intended route.

It is another object of the invention to provide systems, devices, and methods that account for vehicular dynamics in planning a route and commanding a vehicle to drive within the intended route.

### BRIEF DESCRIPTION OF THE DRAWINGS

FIG. 1 is an isometric view of the sensory stabilization system according to the present invention.

FIG. 2 is another isometric view of the sensory stabilization system according to the present invention.

FIG. 3 is another isometric view of the sensory stabilization system according to the present invention.

FIG. 4 is a side elevational view of the sensory stabilization system according to the present invention.

FIG. 5 is a schematic depiction of the three rotational axes that around which the sensory stabilization system according to the present invention operates.

FIG. 6 is an exploded view of the mounting plate components of the sensory stabilization system according to the present invention.

FIG. 7A is an isometric view of the pitch axis assembly of the sensory stabilization system according to the present invention.

FIG. 7B is an exploded view of the pitch axis assembly of the sensory stabilization system according to the present invention.

FIG. 8A is an isometric view of the roll axis assembly of the sensory stabilization system according to the present invention.

FIG. 8B is an exploded view of the roll axis assembly of the sensory stabilization system according to the present invention.

FIG. 9A is an isometric view of the yaw axis assembly of the sensory stabilization system according to the present invention.

FIG. 9B is an exploded view of the yaw axis assembly of the sensory stabilization system according to the present invention.

FIG. 10 is a schematic representation of the showing a particular advantage of the claimed sensory stabilization system and method.

FIG. 11 is a schematic depiction of an embodiment of the invention involved in the generation of a route.

FIGS. 12 and 13 are isometric views of an embodiment of the invention comprising a shock isolation means.

FIG. 14 is a side elevational view and a schematic depiction of a component of the shock isolation means of the present invention.

FIG. 15 is a schematic depiction of the shock isolation means of the present invention in operation and the advantages thereof.

### DESCRIPTION OF THE PRESENTLY PREFERRED EMBODIMENT

The presently preferred embodiment employs the technology discussed herein into an autonomous off-road vehicle that is able to travel at high-speeds. The person of ordinary skill in the art will appreciate that the definition of “high-speed” depends on many variables and may change with time. One of the meanings of “high-speed” relevant to the presently preferred embodiment of the invention relates to the speed that an autonomous off-road robotic vehicle can travel over an unrehearsed route, over off-road terrain that is non-graded and non-flat, and without “blindly” following GPS waypoints. Under such conditions, a present value for an average “high-speed” is approximately 50 mph. Discussed below will be the presently preferred embodiments of the various methods, systems, and devices utilized on the high-speed off-road autonomous vehicle of the present invention.

The invention provides a novel sensory stabilization means and method for the stabilization of the sensory instrumentation preferably used on autonomous off-road vehicles that travel at high-speeds. The skilled artisan will understand, however, that the sensory instrumentation stabilization means can be used in with any technology where stabilization of sensory instrumentation is necessary, including in autonomous vehicles and driver assisted vehicles. In the preferred embodiment, the sensory instrumentation comprises LIDAR and stereovision sensors, but may comprise other sensory means.

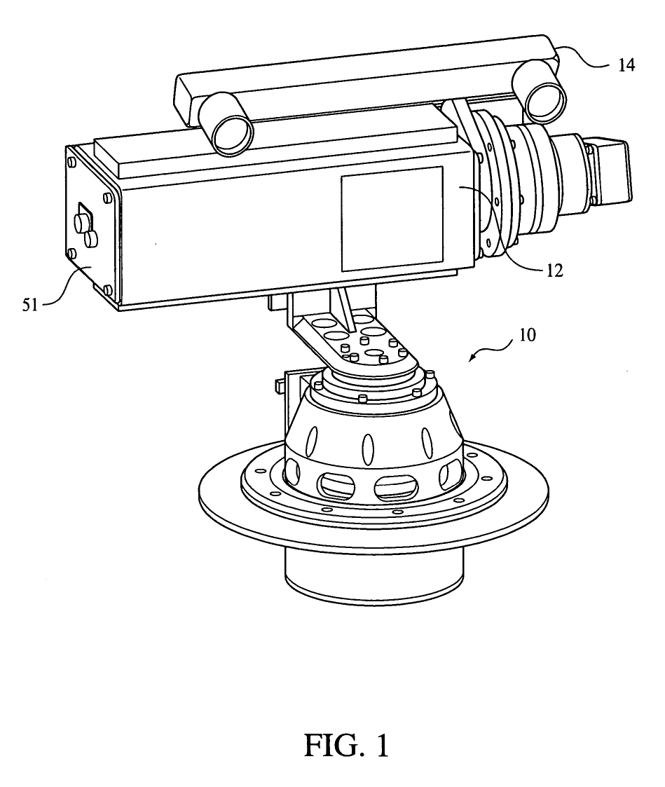

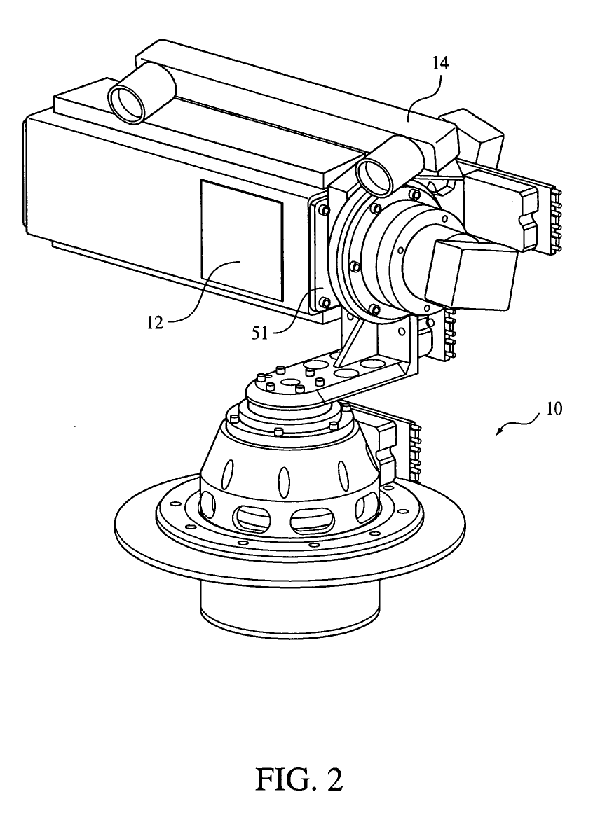

Referring to FIGS. 1 and 2, the sensory stabilization system 10 is preferably a three axes LIDAR and stereovision platform with vector pointing capability. The LIDAR 12 and stereo vision sensors 14 are mechanically coupled to share a common field of view via a fixed optical reference. The sensory stabilization system 10 is capable of being manipulated about three orthogonal axes to effectively attenuate external system rotational excitations encountered in the high-speed off-road environment, and to provide the autonomous vehicle with bounded optical reference vector pointing capability about each axis.

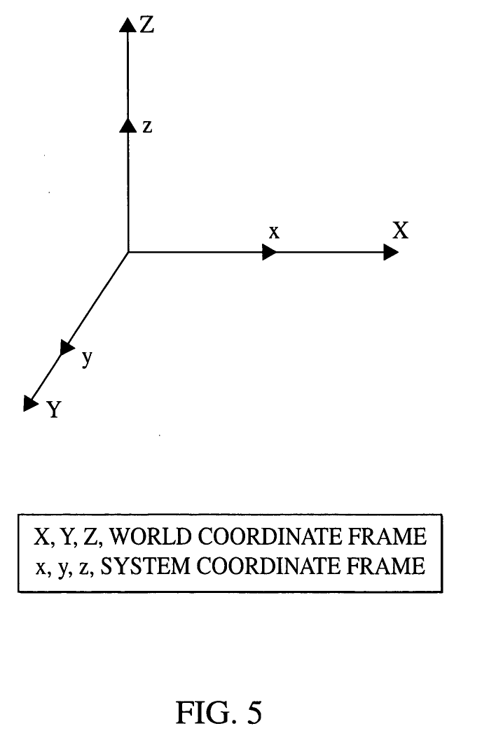

Axes are shown in FIG. 5. Pitch, or movement about the Y axis, is most critically affected by vehicle excitations due to large look out distances associated with downfield targets. Small changes about vehicle pitch axis translate into highly inaccurate instrumentation readings, including changes in linear target illumination. Roll, or movement about the X axis generally effects the tilt at which, for example, LIDAR pixel scan-line illuminates target filed forward of vehicle motion. Yaw, or movement about the Z axis, is generally least effected by vehicle excitations. Yaw movements are preferably planned, controlled movements to effect the heading of the instrumentation.

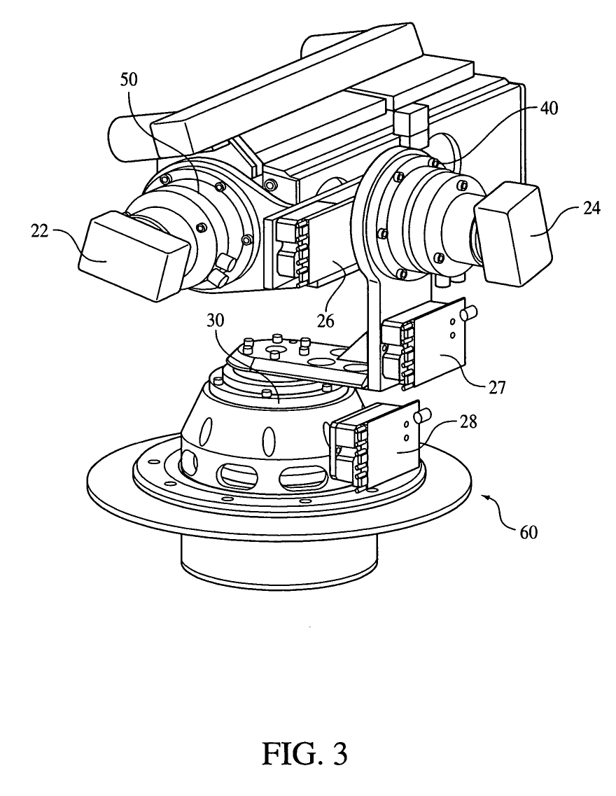

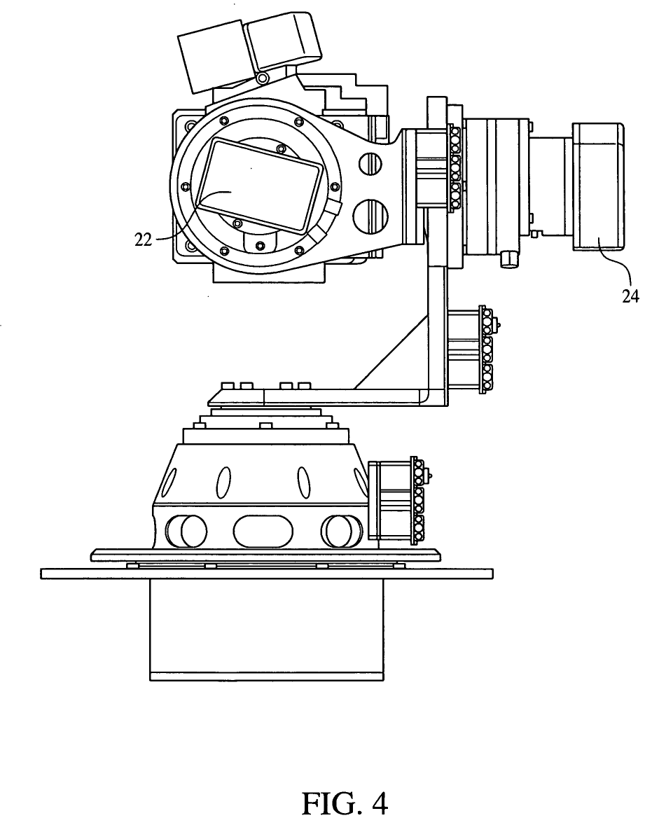

Referring to FIG. 3, novel aspects of the invention include the close coupling of means to sense angular acceleration or velocity 22, 24 to at least one axis assembly, preferably each axis assembly and the control for angularly displacing said axis assemblies. Yaw axis assembly is shown generally as 30. Roll axis assembly is shown generally as 40. Pitch axis assembly is shown generally as 50. In sensing the angular acceleration about each axis of the sensory stabilization system, the system is able to “feel” movement. The system is then programmed to respond to the movement, preferably “in-kind”. For example, if the system senses 10 degrees/cm² of angular acceleration in one direction, the system will respond by actuating the system approximately 10 degrees/cm² in the opposite direction or other processing implementations as discussed below. In this way, the system is able to keep the sensory instrumentation fixed along a selected vector while under the influence of high-frequency excitations. The processing capabilities of the system can be embedded in processors shown on 26, 27, 28, however, the system may employ a single processor or a set of processors unattended to the stabilization means.

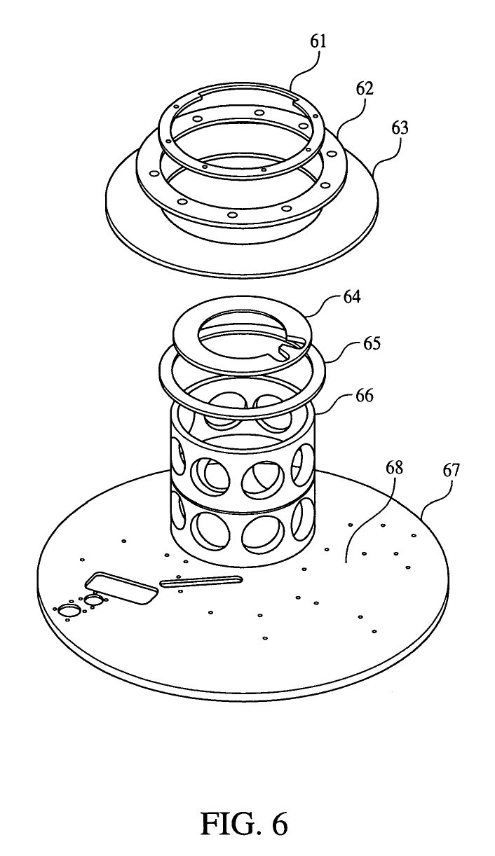

In the preferred embodiment, the sensory instrument stabilizing system comprises three axis assemblies 30, 40, and 50. Referring to FIG. 3, a mounting base 60 is provided for the three axis assemblies shown in FIG. 6, the base comprises a base-plate bottom 67. The base-plate bottom 67 provides mounting real estate and thermal dissipation for sensory equipment, including motor amplifiers, power supplies, solid state relays, PC stack, custom electronic implementation circuit cards, main wiring harness and connectors. Base-plate bottom 67 includes bolt through-hole patterns 68 for both direct mounting to base cylinder 66. The base cylinder 66 provides main structural support for the three-axis sensory stabilization means. The base cylinder ring 66 and base-bearing ring 61 captures main dome rotational bearing (inside diameter) and structurally seat on base cylinder 66 alignment ledge. Base plate top 64 provides bolt patter for actuator on yaw axis assembly 30 and interfaces with base cylinder 66 at top surface. Dome-bearing cap 62 and dome-bearing plate 63 provide structural support and capture enclosure mounting base bolt pattern and also captures main dome rotational bearing (outside diameter).

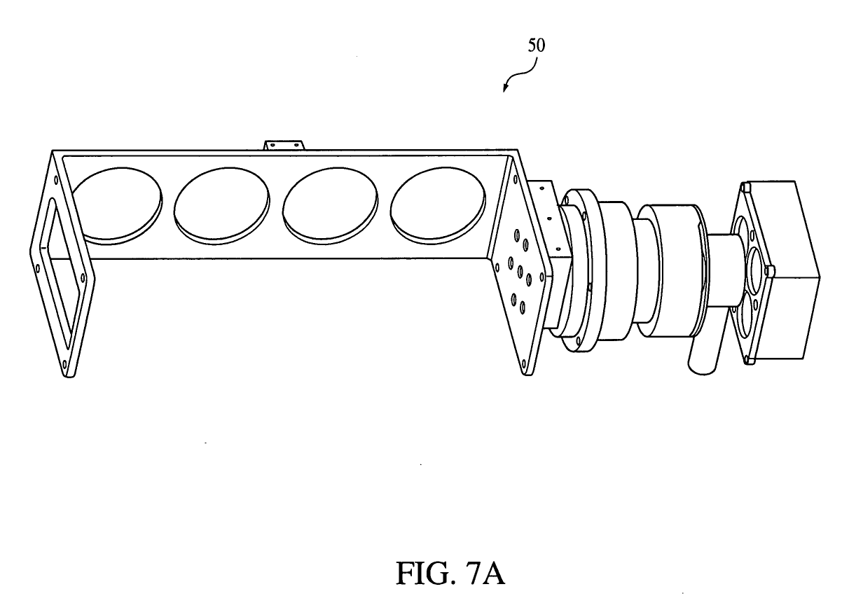

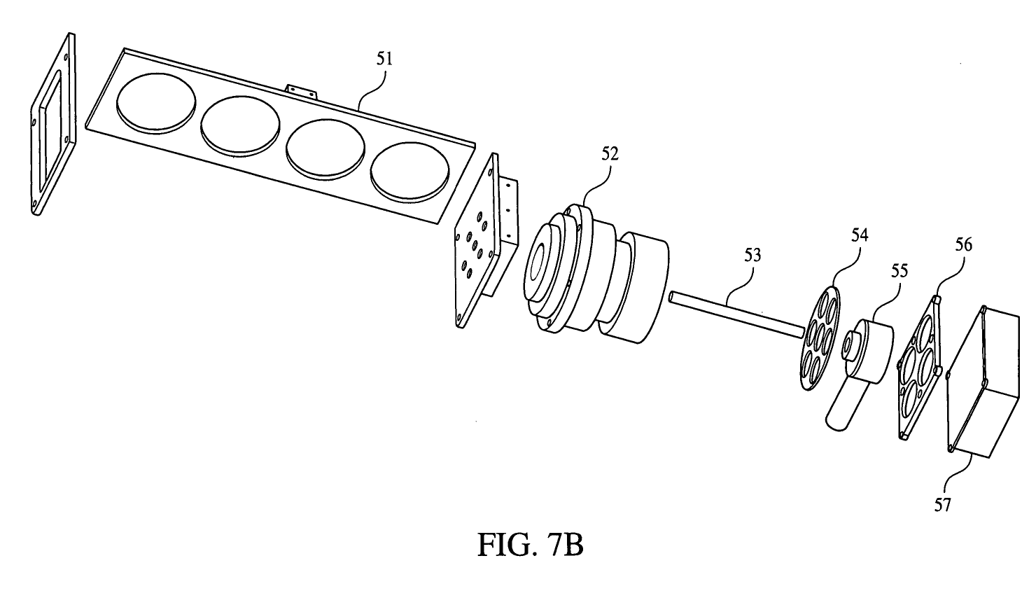

FIGS. 7A and 7B depict the first axis assembly 50, also referred to as the pitch axis assembly, which facilitates rotational motion of sensory instrumentation about the y-axis coordinate. The structural components of the pitch axis assembly fundamentally support sensory instrumentation. Pitch axis assembly is preferably for support of minimal mass and moment of inertia loading. Pitch axis actuator 52 supports and articulates sensory instrumentation. Pitch axis assembly preferably comprises the following machined sub-components. PitchFrame 51 generally houses sensory instrumentation, such as LIDAR and stereoscopic camera as shown in FIG. 1 as 12 and 14. Pitch AxisShaft 53 is coupled with actuator 52 and is used to translate rotational motion from PitchFrame 51 to absolute encoder 55 and means for mounting means to sense angular acceleration or velocity 56. Actuator 52 is preferably a rotational actuator with an internal incremental encoder. Encoder plate 54 is preferably a flexible absolute encoder mounting plate used to fix absolute encoder housing relative to actuator 52 housing. The means to detect angular acceleration or velocity 57 is preferably a fiber-optic gyro. In the presently preferred embodiment, the pitchframe 51 assembly is specifically designed to facilitate mounting of LIDAR scanner and stereovision head mount brackets.

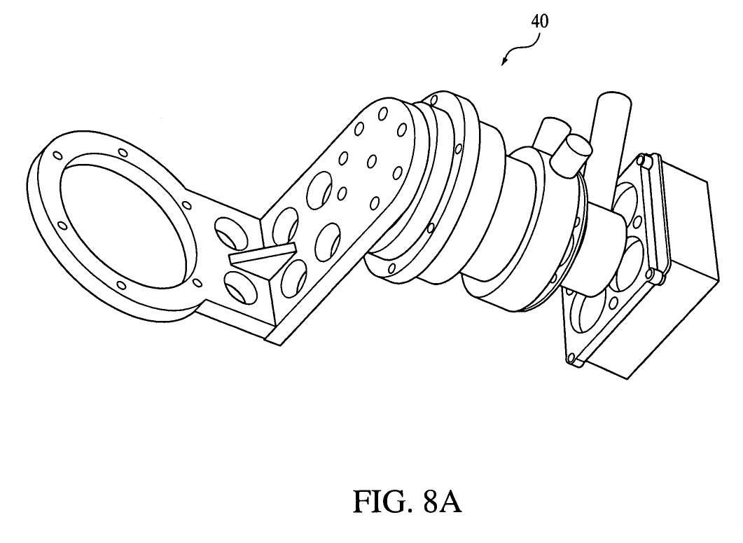

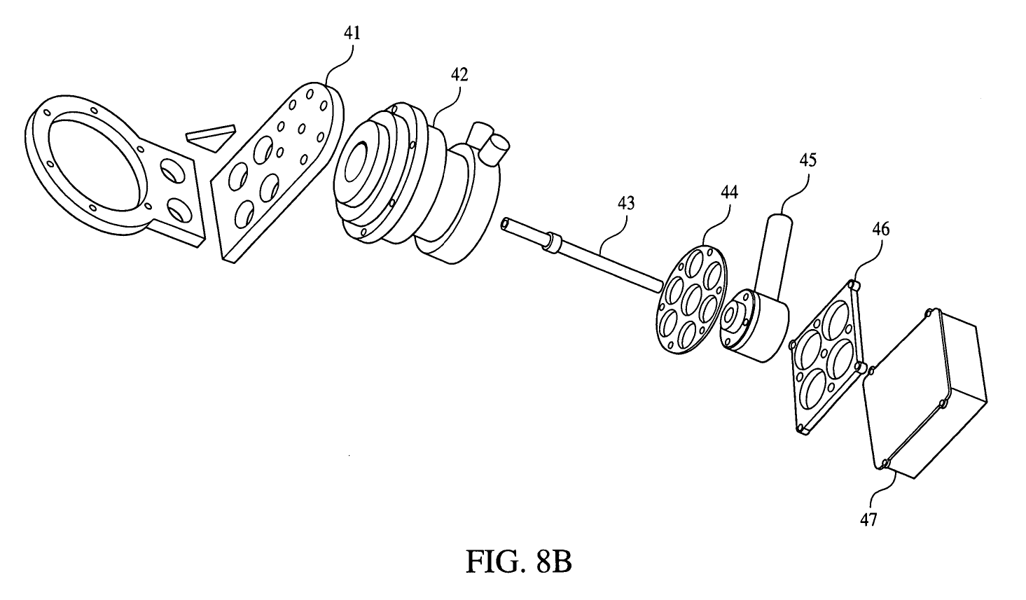

Roll (x-axis) assembly 40 facilitates rotational motion about the x-axis coordinate. Roll axis assembly 40 structural components fundamentally support second-largest mass and moment of inertia. In the preferred embodiment, the critical performance requirement for roll axis is defined lower than that of pitch axis and greater than that of yaw axis, thus ideal for support of intermediate-level mass and moment of inertia loading. Roll-axis actuator 42 supports and articulates intermediate mass of apparatus. Roll-axis assembly 40 comprises the following machined components depicted below in FIGS. 8A and 8B. Roll frame 41 accommodates axis shaft 43. Roll frame 41 is preferably a machined component. Axis shaft 43 is coupled with actuator 42 and is used to translate rotational motion from roll frame 41 to absolute encoder 45 and means for mounting means to sense angular acceleration or velocity or velocity 46. Actuator 42 is preferably a rotational actuator with internal incremental encoder. Encoder plate 44 is preferably a flexible absolute encoder mounting plate used to fix absolute encoder 45 housing relative to actuator housing. Means for mounting means to sense angular acceleration or velocity 46 is preferably a fiber-optic gyro mounting plate, used to mount means for sensing or detecting angular acceleration or velocity 47, preferably a fiber-optic gyro to axis shaft 43.

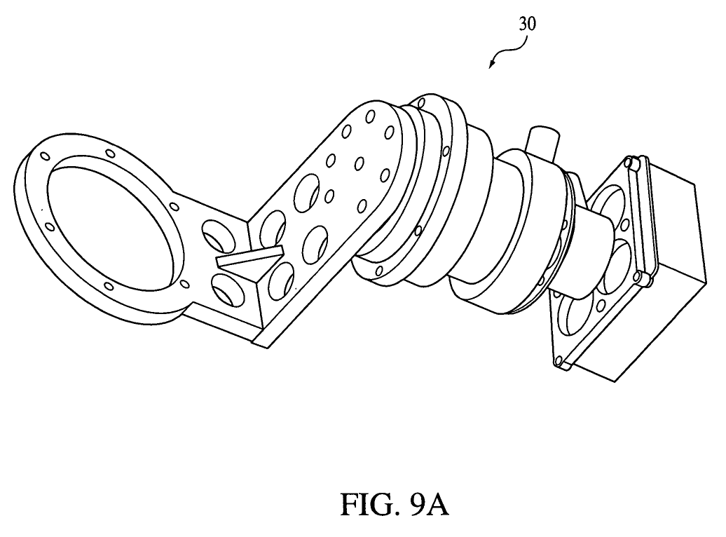

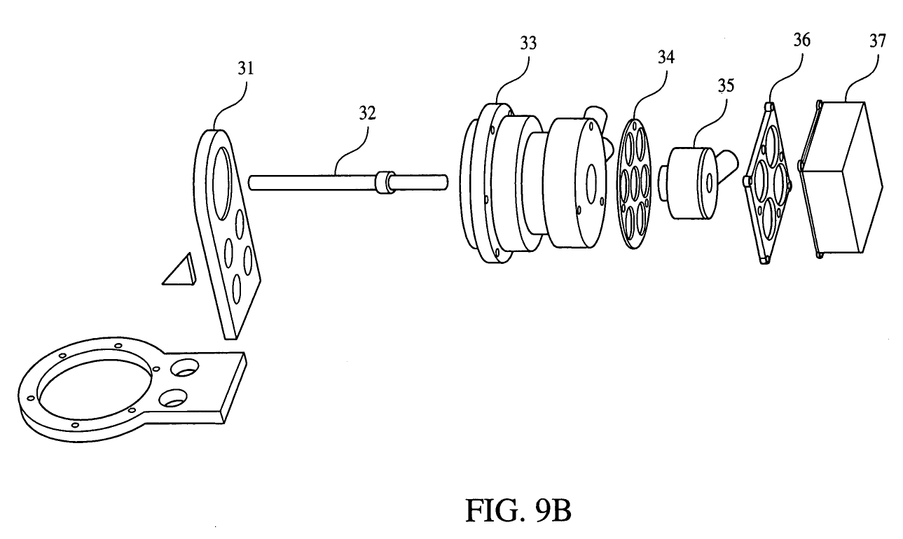

Yaw (z-axis) assembly 30 facilitates rotational motion of optical payload and support mechanism about the z-axis coordinate. Yaw structural components fundamentally support largest mass and moment of inertia. Critical performance requirement for yaw axis is defined lower than corresponding pitch and roll axis and thus ideal for support of larger mass and moment of inertia loading. Yaw-axis actuator 33 supports and articulates full mass of sensory stabilization system 10 (with exception to mounting base assembly shown above). Yaw axis-assembly 30 comprises the following components depicted in FIGS. 9A and 9B below. Yaw frame 31 accommodates axis shaft 32. Axis shaft 32 is coupled with actuator 33 and is used to translate rotational motion from yaw frame 31 to absolute encoder 35 and mounting means for means to detect angular acceleration 36. Actuator 33 is preferably a rotational actuator with internal incremental encoder. Encoder plate 34 is preferably a flexible absolute encoder mounting plate used to fix absolute encoder housing relative to actuator housing. Means for mounting means to sense angular acceleration or velocity 36 is used to mount means for detecting or sensing angular acceleration or velocity 37 to axis shaft 32. Means for sensing angular acceleration or velocity 37 is preferably a fiber optic gyro.

The invention provides a novel method and system for stabilizing a sensory instrument system. In the preferred embodiment, the method is used in combination with the claimed sensory instrument stabilizing system. However, the skilled artisan will appreciate that the method disclosed and claimed herein can apply to any sensory system, particularly those used on off-road vehicles and those used on autonomous off-road vehicles. As sated above, the three axes of the system are orthogonal to each other. When a vehicle, and thus the sensory instrumentation, encounters an excitation, the sensory instrumentation may be displaced in any one of the three axes. The claimed system is able to maintain a stable coordinate frame relative to three possible excitized coordinate frames.

To maintain a stable coordinate frame, the system and method provide for the selection of a vector, for example, to which it is desired to align any one of the three axis assemblies. Vectors can be chosen to direct the sensory instrumentation to actively “gaze” at a given target or to provide reference for stabilization. With respect to stabilization of the sensory instrumentation, the means to sense to angular acceleration or velocity will alert the system to the angular acceleration or velocity experienced by any one of the three axis assemblies. If any of the three axis assemblies experience angular acceleration or velocity, the assembly may be out of line with the selected vector. To realign the axis assembly with the preselected vector, an angular acceleration is calculated that will compensate for the movement caused by the excitation experienced by the axis assembly, or an angular distance oppositely proportional to the angular acceleration or angular velocity experienced by the system. A processing means capable of processing said data will instruct an actuator to apply the calculated angular (in the opposite direction) appropriate to correct for the angular acceleration or velocity experienced by the system. The system not only corrects alignment in response to angular acceleration or velocity readings, the system also responds to actual angular displacement of any of the axis assemblies. Processor is in communication with the means to detect absolute angular displacement and thus reads said displacement. Processor accesses the selected desired vector and calculates the distance necessary to move the displaced assembly back in line with the selected vector. One of the actuators moves the axis assembly the calculated distance.

In certain instances, as will be discussed below a preplanned route is provided. In such situations, for example, the selected vector relative to the yaw axis assembly is the heading provided by the preplanned route. The processor can instruct the yaw axis assembly to adjust to align with a heading vector based on the vehicle's position relative to the preselected route. The system also calculates a pointing vector based on a vehicle heading, the preplanned route, and the speed of the vehicle. For example, vehicles traveling at high will point, i.e., have a yaw axis vector directed, further ahead on the preplanned route than a vehicle traveling at a slower speed.

The selection of a vector to which the pitch axis assembly is aligned can be correlated to the safe stopping distance for the vehicle. Safe stopping distance for a vehicle can be calculated from known sets of values related to the vehicle including, speed of the vehicle, vehicular mass, capable braking force, tire properties, soil type, environmental conditions. Generally, if a vehicle is traveling at a higher speed, the required stopping distance will be greater and vice verse for slower traveling vehicles.

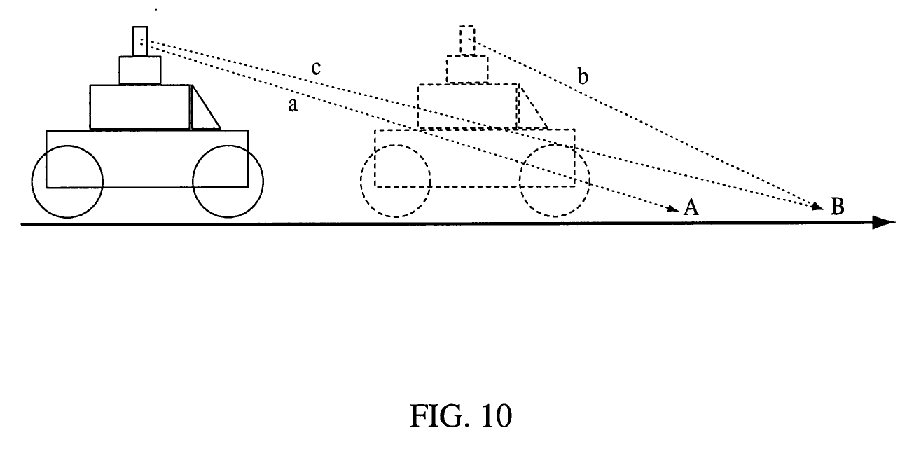

There can be multiple vectors assigned to the multiple axes of the system, and the selection of vectors can depend on the task at hand and/or the speed the vehicle is traveling. For example, a vehicle traveling at a high speed will preferably require that the sensory instrumentation “look ahead” a significant distance in order for the sensory instrumentation to create an accurate picture of the terrain. Therefore, the vector for the pitch axis would be selected such that the vehicle could look out ahead. In situations where the vehicle is traveling at a slower speed, the selected pitch vector may be “steeper” allowing the vehicle to have a lesser look ahead distance than it would have at higher speeds to enable the vehicle to take in more high-resolution detail of the terrain. Also in slow-speed situations, the system may provide for multiple selected pitch and yaw vectors, thereby allowing the sensory instrumentation “sweep” and area and gather terrain related information that it otherwise would have been delayed in receiving with a fixed vector orientation. This is because, for example, if the pitch vector remained fixed, and thus the pitch of the sensory instrumentation remained fixed, the forward sensing horizon would be dependent on forward movement (in flat terrain). For example, as schematically represented in FIG. 10, in conventional systems where a pitch vector is not responsive to vehicle position, dynamics and speed, the vehicle can only “sense” area B upon forward movement (represented by phantom vector (b)). The claimed invention, however, calculates variables, including vehicle speed, position, and may consider route preknowledge and generates a number of pitch vectors (one of which is represented as phantom vector (c)) that would allow it to sense area B with or without forward movement.

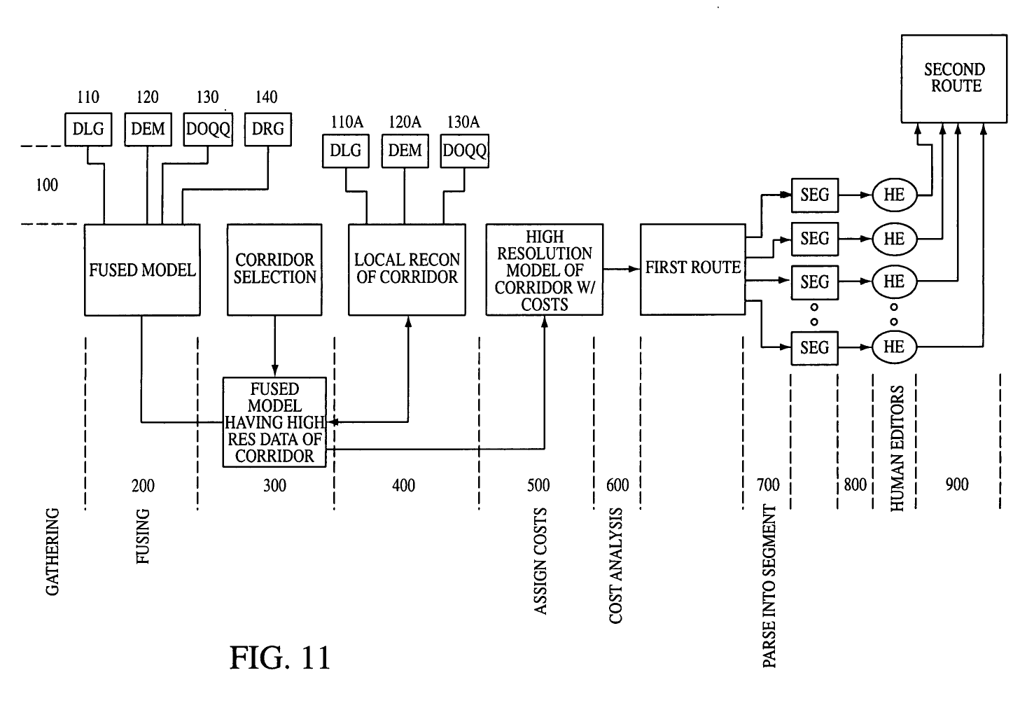

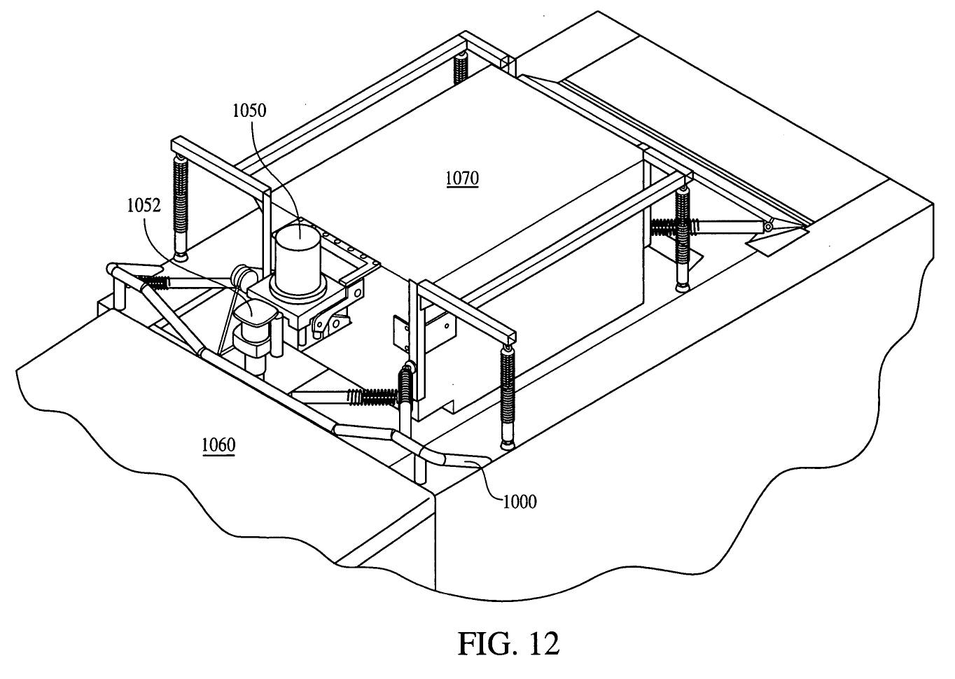

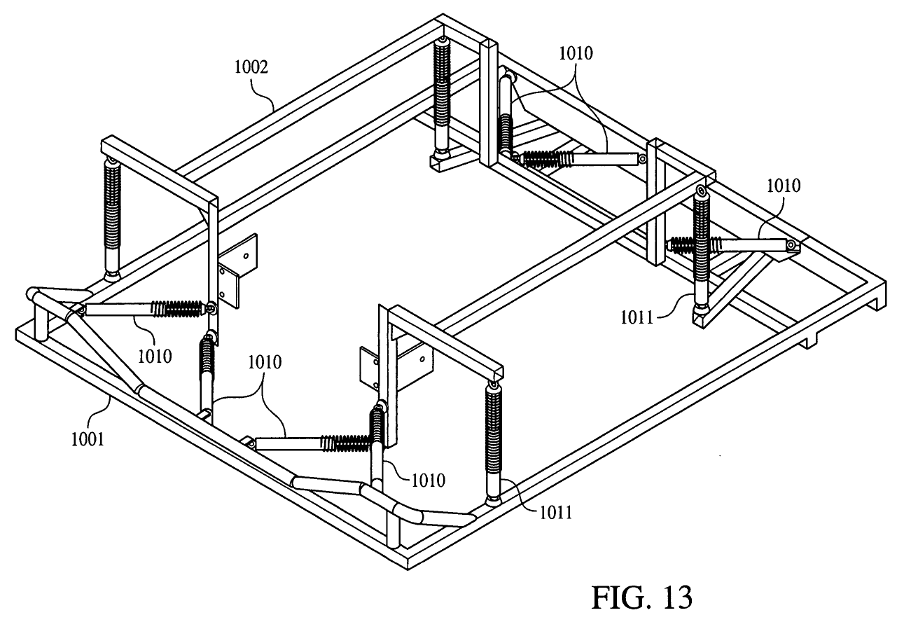

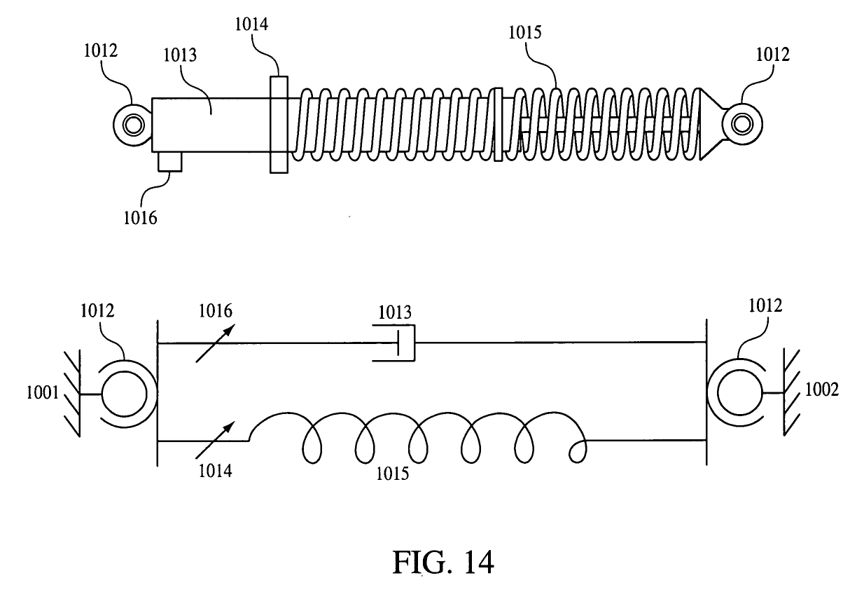

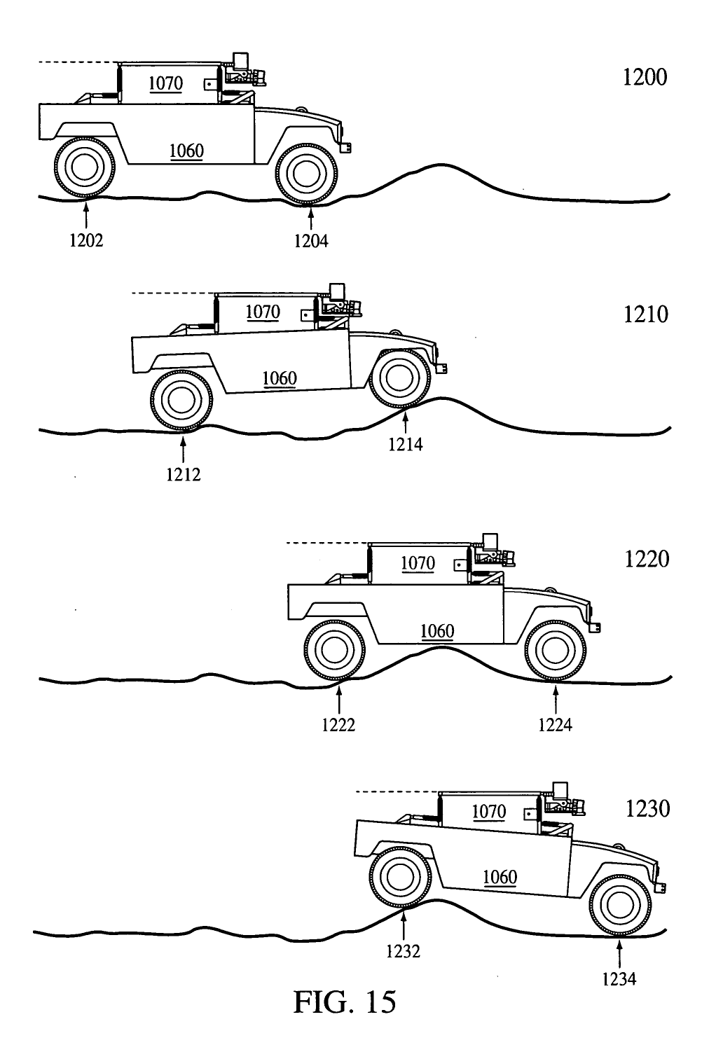

Another aspect of the invention involves the selection and determination of a preselected route on which the vehicle travels. Referring to FIG. 11, the invention comprises gathering mapping data 100 from a variety of sources including USGS topographic maps, aerial surveys, satellite imaging data, and conventional maps. The gathered data comprises digital line graph data (“DLG”) 110, which comprises lines that represent roads, hydrology, railroads, and other geographical features. Gathered data also comprises digital elevation model data (“DEM”) 120, which digitally represents the elevational characteristics of the terrain. Digital ortho quarter quad (“DOQQ”) 130 data comprise images taken from air or space. Digital raster graph (“DRG”) 140 are line drawings that combine DLG and DEM in human readable format and can also comprise geographical borders, city names, and road names. The gathered data is fused 200 into a composite mapping model, thereby, providing a high-resolution model of the selected region in the world.

A travel corridor is selected 300. The corridor may be selected by a person or entity unrelated to the user of the method or the corridor may be chosen by the user. Local reconnaissance 400 of the corridor is preferably conducted. Reconnaissance 400 comprises collecting local high-resolution data of the corridor. In the presently preferred embodiment, reconnaissance comprises passing high-resolution capable sensory gathering instrumentation over or through the corridor to detect and obtain local high-resolution data about the corridor including DLG 110A, DEM 120A, and DOQQ 130A. The corridor data collected as a result of the reconnaissance is related to the only those potions of the fused model representing the corridor. In this way the invention provides, for an ultra high-resolution model of the corridor through or over which a robotic vehicle may travel. Providing a high-resolution map with local corridor data, the claimed invention reduces the amount of memory space and processing capabilities that would be necessary if local high-resolution data was stored for the entire mapping region. Costs values are assigned 500 to the high-resolution mapping data based on terrain variables such as slope, soil type, distance between selected points, and smoothness (or curvature) of path between selected points. These cost values are preferably assigned to the region only within the corridor. Known data form the data gather step 100 is used to assign costs 500, and local high-resolution data collected from the reconnaissance 400 is used to assign cost 500. By implementing reconnaissance data in the cost evaluation, the inventors have found that the method is remarkably successful in providing a high-resolution, high-accuracy map that increases the reliability necessary for accurate and dependable route selection. With the costs known with in the corridor, costs are analyzed 600. In the presently preferred embodiment, a route is generated that has an overall lowest cost value. In an another novel aspect of the invention, the route is then parsed into segments 700. Those segments are assigned to human editors 800. Human editors review route segments against the known mapping data and are able to correct potential errors or strategically undesirable aspects of the route. Human editing results in the generation of a second route 900 having a highly accurate preplanned route for which robotic vehicle is programmed to travel. The method, therefore, forms a route with high-resolution data, local high-fidelity data, and checks the route with human editors, all of which increases the possibility that a robotic vehicle will succeed in traveling from the route's starting point to the route's goal or endpoint.

There are instances where the high-resolution map of the present invention can not ensure that the robotic vehicle will reach its goal. For example, obstacles may arise along the route that were not there when the preplanned route was formed. Therefore, the present invention provides for drive-time perception-based path adjustments to steer the robotic vehicle within the intended corridor. The invention utilizes the stable and reliable data achieved through the use of the embodiments discussed above. According to an embodiment of the present invention, a planner receives an evaluation of the terrain from processing of the sensory equipment. Preferably, the evaluation is represented in a grid form, with each cell in the grid comprising a value representing how costly it will be for the vehicle to traverse that cell. This is presently preferred to as a “cost map”. In the presently preferred embodiment, the cells are on the scale of 20 cm, however the skilled artisan will appreciate that cell size may vary. In order to address the high speeds and vehicle excitations yielding varied results from the scanner, the cost map is preferably segmented and compressed. An example of such compression is as follows: If a mini-segment of the cost map was:

5 4 3 2 1

1 9 2 8 6

1 2 3 4 5

7 7 7 7 7

The invention provides that the cost map be compressed to:

7 9 7 8 7

By taking the maximum of each column, the invention ensures that potential obstacles are not overlooked. In the presently preferred embodiment, the map cells are smaller than the vehicle our vehicle width. Therefore, the invention provides that the costs are “smeared” across the width of the cost map. An example of “smearing” is as follows: If there is an obstacle located at one cell, the invention will provide that vehicle keep a safe distance from that obstacle. If the vehicle width is 2 cells, and the row of costs is 1 2 3 4 5, the invention provides that the costs are adjusted to 2 3 4 5 5 to keep the vehicle a safe width from the obstacle.

Next, a search for safe terrain is performed. Each cell of the cost map is evaluated, and if the cost of traversing that cell is below a given threshold, then that cell is safe to traverse. Cells next to each other that are safe are preferably strung together into “safe segments”. The segments provide a representation of a possible safe route, i.e. flat area, on which the vehicle should be instructed to travel.

Preferably, the costs of the segments are cleared and reassigned. The generation of new costs is generated sing the following formula, which calculates each cell's new cost:
newCost=(distance from center of segment)*(range of possible costs that can be assigned to safe cells)/(center of the segment)

The minimum cost applied to the safe segments is preferably a very small value. The maximum cost is proportional to the size of the segment. For example, if the segment is larger, then higher costs may be applied to the sides of the safe segments, because it is likely that there is safe terrain on which the vehicle can drive farther from the hazardous terrain on the sides of the safe terrain.

Once all the above processing is achieved, the invention provides that a path is generated. The invention employs an algorithm to efficiently sum up all of the costs from the vehicle position to the end of the cost map, and to select a path which generates the smallest path. As an example, is a cost map is represented as:

9 9 8 9 9

8 7 7 7 8

6 5 5 5 6

1 1 * 1 1

Where * is the vehicle position, the path generated would be something like a straight line to the 8. (So, *, 5, 7, 8). In the preferred embodiment, the “vehicle position” is some distance out in front of the vehicle, depending on speed of the vehicle. The faster the vehicle is driving, the farther out the planner's representation of vehicle position is. This is because the planner will always generate an optimal path (optimal preferably meaning lowest cost), and that can change as the vehicle position updates. The skilled artisan will appreciate that the above examples are simplified for purposes of description.

In an important aspect of the invention, it is undesirable to have the vehicle's “next point” to be changing with high-frequency leading to jolty behavior of the vehicle. Therefore, the invention provides that the above method is performed on data that represents terrain out an appropriate distance ahead of the vehicle.

A novel aspect of the present invention is that the consideration of a dynamic vehicle model in route selection and in perception based path adjustments to steer a vehicle. A robotic vehicle is constrained by dynamics that limit what a vehicle can and cannot do. For example, a vehicle according to the present invention instantly go from 50 miles an hour to 0 miles per hour. A vehicle according to the present invention will react differently to different surfaces, e.g., sand, gravel, asphalt. The present invention provides that a dynamic model of the vehicle is made in order to gauge the appropriateness of, for example, a selected speed through a route segment, a selected turn within a given route segment, etc. A dynamic model of the robotic vehicle comprises variables such as mass, chassis stiffness, suspension, and tire-to-ground friction values. Thresholds or cost values are assigned and used by the processing means in the calculation of costs of an intended route or intended driving path. The dynamic vehicle variables, therefore, may be added to the consideration of costs, and therefore are used to provide a route or intended steering path that is more likely achievable by the vehicle.

Shock isolation means 1000 described here is a method for smoothing the bounce and lurch of payload 1070, and suppressing the shock that is otherwise experienced by payloads like sensors 1050, 1052, computers and devices that ride aboard driverless off-road vehicles. The smoothing of the sensor motion 1200, 1210, 1220, 1230 facilitates the generation of full-coverage, high fidelity terrain models and the suppression of the shock precludes the degradation of device performance and improves the survival of payload devices for enabling driverless navigation of off-road terrain at high speed.

This invention is a method and means for suppressing bounce, lurch and shock of sensors, computers and devices to facilitate the generation of full-coverage, high fidelity terrain models and the performance and survival of devices for enabling driverless navigation of off-road terrain at high speed. The invention has been embodied and shown to facilitate a quality of sensor stabilization not previously achieved. The invention has enabled a proportion of terrain coverage not previously achieved. The invention has enabled a speed of autonomous offroad driving over harsh terrain that was not previously achieved. The invention has softened the ride for sensors, motion components and sensitive devices in a manner that performance and survival succeed, experiencing less than 2.5 g's, which is shock-isolated from input impulses exceeding 25 g's.

Without shock isolation and energy absorption to suppress high-amplitude and high-frequency motion, payloads like sensing and electronics bounce and shake violently while driven aboard any vehicle currently driven by computer versus human at high speed over offroad terrain. The harsh motions of sensors and devices are excited by vehicle elements like wheels or tracks impacting terrain features like rocks, potholes, washouts and road features like ripples (washboard), berms and turns. Even slower, human-driven vehicles are impulsed by such features, but the impulses conveyed to such vehicles are mild. Impulses 1214, 1232 generated by the same features are extreme and threatening to the performance and survival of high-speed, computer-driven vehicles. Payload and chassis motion are benign at slow speed, since reaction to irregular terrain is quasi-static. Payload and chassis motion are violent when driving is directed at high speed by computer guidance over offroad terrain. Computer driving is currently inferior to computer driving. The imperfect perception, planning and reactions of computer driving subject a vehicle to impacts and impulses that would ordinarily be avoided by skilled human driving. Impulse magnitude and frequency are intrinsically high at high speed. Impulse is proportional to the magnitude of an encountered feature and proportional to the speed at which a feature like a rock is encountered by a vehicle, so larger the feature and the faster the driving, the greater the impulse magnitude. The frequency of impulse is proportional to the speed at which a series of features, like the bumps on a trail, or rocks on a berm are encountered in sequence, so the faster the speed, the higher the frequence of impulse.

The adverse consequences of erratic payload motion affect autonomous navigation in three ways: (1) terrain model fidelity is degraded by erratic payload motion, (2) terrain model coverage is degraded when lurching motion misses a patch of terrain or sweeps sensor gaze too quickly past terrain, and (3) lifetime survival and performance of components like spinning mirrors, disks, connectors and electronics are degraded by damaging doses of shock loads in ways that do not degrade or impair the performance of human drivers. The following components are essential devices for implementation and execution of autonomous navigation:
(1) Sensors that bounce and shake violently are currently unable to model terrain at the fidelity required for high-speed computer navigation. For example, laser scanner sensors “read” terrain by “scanning” or “sweeping” range readings across a swath of terrain. The motions that bounce and shake the sensor superimpose onto the motions of driving and steering to jostle sequential sensor rays in erratic patterns that are not precisely interpretable by computers to create quality terrain models at high speed. Fidelity refers to the resolution and ground truth with which such sensors, and also cameras and radars read terrain and generate accurate models.
(2) Sensors that bounce can be diverted from viewing segments and pockets of terrain, so the resulting terrain models may exhibit gaps and holes that are not modeled since they are not seen by the sensors. For example, a laser line scanner views terrain by sweeping its range sensor across the terrain to generate lines of data that correspond to transects (cross-sections) of the terrain. When driving is slow and terrain is benign, the cross-sections are frequent and dense on the ground, so the terrain is fully covered by sensor measurements, and it is possible for computers to accumulate these into complete, continuous surface models without gaps or holes. Such full, continuous models are referred to as “complete coverage”. When driving is fast and terrain is rough, then bouncing might cause a scanning sensor to pitch to the sky, then to nose to the ground, or lurch to the side, and in so doing, the sensor might miss a swath or patch of terrain. Alternately, pitching and lurching may cause sensors to gather only sparse data on swaths or patches of terrain. The terrain exists as a continuous surface, but regions of the surface are missed or sparsely observed by the sensing. This creates gaps of terrain that were not sensed, resulting in terrain models that exhibit “incomplete coverage” or “sparse coverage” Incomplete or sparse coverage cause
(3) Component performance and component survival degrade from sustained high impulses, and they are damaged by occasionally severe impulses. Pulsing and shaking affect moving parts like scanner mirrors and computer disks. Violent motion degrades or damages connectors and conductors.

The invention has standalone merit for smoothing sensor 1050, 1052 view and component ride. 1200, 1210, 1220, 1230 The invention is further useful as a passive isolation stage that softens the ride of payload 1070 components prior to an active isolation stage such as an electromechanical gimbal 1050 detailed elsewhere in this patent claim. In this multi-stage shock isolation scenario, passive shock isolation invented and described here is effective at suppressing large disturbances, high frequencies of impulse and high magnitudes of impulse 1214, 1232 passively and prior to finer, absolute stabilization that is possible by electromechanical means after gross impulse motion has been suppressed by this invention. The fine, small-angle, absolute, less-responsive active stabilization can not succeed alone at current state of implementation without use of a passive isolation pre-stage, as described here.

Traditional vehicle suspensions use springs and shock absorbers to soften impacts and smooth chassis motion. This invention benefits from the ordinary suspension of springs, shock absorbers, linkages and deformable tires that are customary for smoothing the ride of a vehicle chassis. This invention benefits from traditional suspension, and is mounted on and above a traditional chassis, but this invention makes no claim of innovation regarding traditional suspension and chassis.

This invention 1000 operates above a chassis 1060, and acts to isolate shock accelerations and motions experienced at a payload 1070 from impulses encountered at the wheels 1202, 1204, 1212, 1214, 1222, 1224, 1232, 1234. The accelerations observed at the payload 1070 are typically an order of magnitude lesser than that experienced at the chassis 1060. For example, an embodiment of this invention, driving autonomously for 7.4 miles over offroad terrain 1200, 1210, 1220, 1230 at peak speeds reaching 36 miles per hour experiences continuous impulses 1202, 1204, 1212, 1214, 1222, 1224, 1232, 1234 from terrain features. Peak impulses like 1214 and 1232 generated chassis 1060 accelerations reaching magnitude 25 g, but the peak accelerations measured at the payload 1070 are not observed to exceed 2.5 g, and the trajectory of payload 1070 motion is smooth and devoid of the high-frequency motions observed at the chassis 1060.

No claim of innovation is made here for compliance components like springs 1015 and energy absorber elements like dampers 1013 of common shock isolation practice, nor their mechanical means for tuning 1016, mounting 1012 and preloading 1014 or pre-biasing. The innovation of this invention lies in novel configuration, mounting, tuning and pre-loading, or pre-biasing of an assembly of these devices, and their composite dynamic effect on a payload 1000.

FIG. 1000 shows a preferred embodiment of shock isolation in which compliance and energy-absorbing components 1010, 1011 are sized, preloaded and tuned in a configuration that effectively suppresses motion and shock-isolates a massive payload 1070 carrying terrain sensors 1050, 1052 and containing sensitive components aboard a computer-driven, high-speed, off-road vehicle 1060. The orthogonal configuration of the compliance and energy-absorbing components 1010, 1011 essentially decouples the vertical and horizontal dynamics, simplifying the tuning of spring pre-load 1014 and dampening characteristics 1016. It allows translations in all directions without inducing substantial rotations that might be coupled to translations. It provides clearances and ranges of motion that insure against collision with vehicle parts or self-collision between or within the compliance and motion components of the invention. It provides sufficient energy absorption to preclude amplification of impulse magnitude, and to insure the decay of kinetic energy and oscillation that might be exacerbated by compliance.

The invention suspends a massive payload 1070 (on which sensors ride, and within which vulnerable components and moving parts reside) above a vehicle chassis 1060 using compliant and energy-absorbing elements 1015, 1013 that are tuned 1016, preloaded 1014 and arrayed 1010, 1012 in such a manner that motions of the payload are smoothed, diminished and absorbed to suppress bounce, lurch and shock. A vertical array of compliant and energy-absorbing elements 1011 span between multiple connection points on the vehicle frame 1001 and a related set of multiple connection points on the payload frame 1002 to provide primarily vertical support and float for the payload 1070. A horizontal array of compliant and energy-absorbing elements 1010 span between multiple connection points on the vehicle frame 1001 and a related set of multiple connection points on the payload frame 1002 to provide primarily horizontal support and constraint for the payload 1070. The composite configuration of all these elements 1010, 1011 preclude significant excursion on all motion axes of the massive body without impacting other vehicle components or self-impacting with moving parts of this invention. The principal function of this invention is to mitigate impulses that source from driving over irregular, off-road terrain, but it is also important to preclude the generation of unintended internal impulses that might occur from unintended internal collisions within the invention and between the invention and vehicle parts like the payload 1070 hitting the chassis frame 1001 or a compliance element 1015 hitting another compliance element. Such internal impacts would otherwise generate undesirable lurch and shock that would degrade smooth sensor motion or degrade device performance in the same manner that terrain impulses otherwise bounce and jostle the sensors and devices. Internal shock might otherwise occur from unintended self-collision within the moving parts of the invention.

All axes of the massive body motion are constrained and all impedances (combinations of stiffness 1015, mass and energy-absorbing properties 1016) are sufficient in magnitude and alignment to support and limit the excursion of the payload 1070 on all axes such that large motions of the compliant and energy-absorbing elements 1010, 1011 do not experience large-displacements or geometric reorientation that can cause degenerate impedance “mechanisms” (sometimes called mechanism singularities) nor does the invention “bottom out” on the chassis 1060, or impact on the chassis frame 1001, or on compliance components 1015 or on other vehicle parts. Compliances 1015 are preloaded 1016 and energy-absorbing properties are adjusted 1014 to achieve this performance.

High stiffness, energy-absorbing and pre-loading fail to shock-isolate a massive body. Low stiffness, energy-absorbing and pre-loading also fail to shock-isolate a massive body. Inappropriate geometric configuration, orientation and mounting of compliance and shock-absorbing components fail to shock-isolate a massive body. A subtlety of the invention is that the geometry, compliance and energy-absorbing properties, preloading and tuning of the impedance elements cannot transmit too much or too little of the terrain disturbance to the massive body, nor underconstrain nor overconstrain the suspension of the massive body, nor over-absorb, nor under-absorb the kinetic energy of the massive body. Over-stiff components transmit too much of the terrain and chassis excitations to the massive body. Under-stiff, under-absorbing or under-biased components intended to support and float a massive body are the same means by which the disturbing chassis impulses are transmitted to a massive body, so the same components that suppress shock are the components that transmit shock. Impedance properties and preload bias cannot be too great or too small, and energy absorption must be sufficient, throught the range of geometries that pertain during motion excursion. Impedances and preloading of the compliance and energy-absorbing elements are tuned 1014, 1016 to not inordinately alter to soften or stiffen or re-orient during large excursions of the massive body. Configuration is specialized to decouple the effects of translation and rocking to minimize angular motion of the suspended massive body, since terrain model sensing mounted to the massive body is more vulnerable to angular motion than to translation motion.

While the foregoing has been set forth in considerable detail, it is to be understood that the drawings and detailed embodiments are presented for elucidation and not limitation. Design variations, especially in matters of shape, size and arrangements of parts maybe made but are within the principles of the invention. Those skilled in the art will realize that such changes or modifications of the invention or combinations of elements, variations, equivalents or improvements therein are still within the scope of the invention as defined in the appended claims.

1. A sensory instrument stabilizing system comprising:
a. a first axis assembly operable to be rotated about a first axis, the first axis assembly closely coupled with an actuator and a means to detect angular acceleration about the first axis;
b. a second axis assembly coupled with the first axis assembly and operable to be rotated about the a second axis, the coupled first axis assembly and second axis assembly permitting the stabilizing system to move about the first and second axis, second axis assembly closely coupled with an actuator and a means to detect angular acceleration about the second axis;
c. a third axis assembly coupled with the first axis assembly and the second axis assembly and operable to rotated about a third axis, the coupled first axis assembly, second axis assembly, and third axis assembly permitting the stabilizing system to be rotated about the first, second and third, the third axis assembly closely coupled an actuator with a means to detect angular acceleration about the third axis; and
d. a processing means in communication with each means to detect angular acceleration and each actuator, the processing means programmed to calculate an angular distance necessary to off-set detected angular acceleration and operable to instruct at least one of the actuators to actuate at least one of the assemblies a said calculated distance.

2. The sensory instrument stabilizing system of claim 1, wherein said first, second, and third axes are orthogonal to each other.

3. The sensory instrument stabilizing system of claim 1, wherein said first axis is yaw, said second axis is roll, and said third axis is pitch and wherein said first axis assembly has a moment of inertia higher than a moment of inertial of second and third axis assemblies and the second axis assembly has a moment of inertia higher than that of the third axis assembly.

4. The sensory instrument stabilizing system of claim 1, wherein the first, second, and third axis assemblies further comprise a means for detecting an absolute angular displacement for the first, second, and third axis assembly respectively.

5. The sensory instrument stabilizing system of claim 1, wherein the means to detect angular acceleration comprises a fiber optic gyro.

6. The sensory instrument stabilizing system of claim 1, further comprising a sensing means mounted to the third axis assembly.

7. The sensory instrument stabilizing system of claim 6, wherein the sensing means comprises a LIDAR.

8. The sensory instrument stabilizing system of claim 6, wherein the sensing means comprises stereoscopic camera.

9. The sensory instrument stabilizing system of claim 6, wherein the sensing means comprises a video camera

10. A sensory instrument stabilizing system comprising:
a. a first axis assembly operable to be rotated about a first axis, the first axis assembly closely coupled with an actuator and a means to detect angular velocity about the first axis;
b. a second axis assembly coupled with the first axis assembly and operable to be rotated about the a second axis, the coupled first axis assembly and second axis assembly permitting the stabilizing system to move about the first and second axis, second axis assembly closely coupled with an actuator and a means to detect angular velocity about the second axis;
c. a third axis assembly coupled with the first axis assembly and the second axis assembly and operable to rotated about a third axis, the coupled first axis assembly, second axis assembly, and third axis assembly permitting the stabilizing system to be rotated about the first, second and third, the third axis assembly, the third axis assembly closely coupled with an actuator and with a means to detect velocity about the third axis; and
d. a processing means in communication with each means to detect angular velocity and each actuator, the processing means programmed to calculate an angular distance necessary to off-set said detected angular velocity and operable to instruct at least one of the actuators to actuate at least one of the assemblies said calculated distance.

11. The sensory instrument stabilizing system of claim 1, wherein said first, second, and third axes are orthogonal to each other.

12. The sensory instrument stabilizing system of claim 10 wherein said first axis is yaw, said second axis is roll, and said third axis is pitch and wherein said first axis assembly has a moment of inertia higher than a moment of inertia of the second and third axis assemblies and the second axis assembly has a moment of inertia higher than the moment of inertia of the third axis assembly.

13. The sensory instrument stabilizing system of claim 10, wherein the first, second, and third axis assemblies further comprise a means for detecting an absolute angular displacement for the first, second, and third axis assembly respectively.

14. The sensory instrument stabilizing system of claim 10, wherein the means to detect angular velocity comprises a fiber optic gyro.

15. The sensory instrument stabilizing system of claim 10, further comprising a sensing means mounted to the third axis assembly.

16. The sensory instrument stabilizing system of claim 15, wherein the sensing means comprises a LIDAR.

17. The sensory instrument stabilizing system of claim 15, wherein the sensing means comprises stereoscopic camera.

18. The sensory instrument stabilizing system of claim 15, wherein the sensing means comprises a video camera

19. A method to stabilize sensory instrumentation on a vehicle, comprising the steps of:
a. selecting a vector;
b. detecting angular acceleration relative to the rotation of said instrumentation;
c. calculating an angular distance necessary to align said instrumentation with said selected vector in response to said detected angular acceleration; and
d. displacing said instrumentation the calculated angular distance.

20. A method to stabilize sensory instrumentation on a vehicle, comprising the steps of:
a. selecting a vector;
b. detecting angular velocity relative to the rotation of said instrumentation;
c. calculating an angular distance necessary to align said instrumentation with said selected vector in response to said detected angular velocity; and
d. displacing said instrumentation the calculated angular distance.

21. The method of claims 19 or 20 further comprising the steps of:
a. detecting an angular displacement relative to the selected vector; and
b. calculating an angular distance necessary to align said instrumentation with said vector; and
c. displacing said instrumentation the calculated distance

22. The method of claims 19 or 20 further comprising the step of detecting a forward speed of the vehicle.

23. The method of claim 19 or 20 further comprising the step of determining a safe stopping distance of the vehicle and selecting a vector that is within said safe stopping distance.

24. The method of claim 19 or 20 further comprising the steps of:
a. providing a preplanned route; and
b. pointing the instrumentation in the direction of the preplanned route.

25. A method for generating a high accuracy route for a robotic vehicle comprising the steps of:
a. gathering mapping data related to a region of intended travel and fusing said mapping data into a model, said region and model corresponding to a first actual location;
b. providing a travel corridor within said model, said travel corridor corresponding to a second actual location within said first actual location;
c. running a sensory means over said second actual location to collect high-resolution data related to the said second actual location;
d. assigning a plurality of travel costs associated with said second actual location based on the collected data related to conditions of said actual corridor and said mapping data;
e. generating a first route through said corridor based on an evaluation of said costs.

26. A method for generating a high accuracy route for a robotic vehicle comprising the steps of:
a. gathering mapping data related to a region of intended travel and fusing said mapping data into a model, said region and model corresponding to a first actual location;
b. providing a travel corridor within said model, said travel corridor corresponding to a second actual location within through said first actual location;
c. assigning a plurality of travel costs associated with said second actual location based on the collected data and said actual corridor and said mapping data; and
d. generating a first route through said corridor based on an evaluation of said costs.

27. The method of claims 25 or 26 further comprising the steps of:
a. parsing said first route into route segments;
b. assigning said segments to human editors;
c. human editing said route segments; and
d. generating a second route comprising said human edited route segments.

28. The method of claims 25 or 26 further comprising the step of assigning waypoints within said first routes based on said evaluation.

29. The method of claims 25 or 26 further comprising the steps of:
a. assigning speed values to said first route based on said evaluation; and
b. requiring said vehicle to travel a selected speed based on said speed values.

30. The method of claim 27 wherein said step of human editing further comprises determining physical, geographical, and legal boundaries.

31. The method of claim 25 or 26 wherein said collected data and said mapping data relates to a distance between at least two selected points in the second actual location.

32. The method of claims 25 or 26 wherein said collected data and said mapping data relates to slope between at least two selected points in the second actual location.

33. The method of claims 25 or 26 wherein said collected data and said mapping data relates to the soil type between at least two selected points in the second actual location.

34. The method of claim 27, wherein said step of parsing the first route into segments further comprises parsing the first route into equal length segments.

35. A method for providing perception-based path adjustments to steer a robotic vehicle comprising the steps of:
a. providing a preselected corridor through which the vehicle is intended to travel;
b. collecting localized sensory data of the corridor upon which the vehicle is traveling;
c. assembling the collected data into a model;
d. assigning a first set of travel costs to selected portions of the model;
e. aggregating said portions into aggregates;
f. determining the maximum travel cost of the aggregates and assigning a second set of costs wherein said second set of costs comprises the maximum travel cost of the aggregate;
g. evaluating said second set of costs; and
h. providing a vehicle path based on said evaluation of said second set of costs.
